(19) United States
(12) Patent Application Publication
(10) Pub. No.: US 2011/0178696 A1
(43) Pub. Date: Jul. 21, 2011

(54) CONTROL UNIT FOR ONE OR MORE ELECTROMAGNETIC ACTUATORS OF A HEAT ENGINE VALVE, AND DIFFERENT ASSEMBLIES OF SUCH CONTROL UNITS AND SUCH ELECTROMAGNETIC ACTUATORS

(75) Inventors: Nicolas Gelez, Le Pecq (FR); Ronan Danioux, Cergy (FR); Boris Bouchez, Saint Germain En Laye (FR)

(73) Assignee: VALEO SYSTEMES DE CONTROLE MOTEUR, Cergy Pontoise Cedex (FR)

(21) Appl. No.: 13/056,330

(22) PCT Filed: Jul. 30, 2008
(86) PCT No.: PCT/FR2008/001133

§ 371 Date: Apr. 11, 2011

(51) Int. Cl. F02D 41/00

(52) U.S. Cl. 701/105

(57) ABSTRACT

The invention relates to a control unit (19, 20) for one or more electromagnetic actuators (15, 16) of the valve (13, 14) of a heat engine, wherein said control unit can be connected by linking means (24, 25) to a main management unit (21) of the heat engine, the control unit (19, 20) acting under the action of at least a first driving program for driving the actuator based on a signal transmitted to the control unit by the main management unit via the linking means. According to the invention, the control unit includes a memory (26, 27) containing backup information and, in the case of a signal interruption, the control unit runs a second driving program for driving the actuator based on workaround information. The invention also relates to different assemblies of such control units and such electromagnetic actuators.

The present invention relates to a control unit for one or more electromagnetic actuators of a heat engine valve, such as those used to move motor vehicles. It also relates to various assemblies of such control units and such electromagnetic actuators.

### BACKGROUND OF THE INVENTION

A heat engine generally comprises cylinders which define combustion chambers which are sealed on the one hand by a cylinder block and on the other hand by a reciprocating piston connected to a crankshaft. The engine comprises ducts for the intake of fuel into the combustion chambers and exhaust ducts for the burnt gases, these ducts being respectively equipped with intake valves and exhaust valves. The intake and exhaust valves are actuated to obtain a four-stroke engine operating cycle, namely, for each combustion chamber, an intake phase in which the air and the fuel are introduced into the combustion chamber, a phase for compression of the air and fuel mixture, an expansion phase in which the burnt gases resulting from the combustion of the mixture expand and an exhaust phase in which the burnt gases are evacuated out of the combustion chamber, these phases following one another in each cylinder over two revolutions of the crankshaft.

To actuate each valve, it is known to use an electromagnetic valve actuator driven by a control unit connected by linking means to a main management unit for the heat engine, namely the engine control unit, or ECU, which has a memory containing a number of mappings as a function, for example, of the outdoor temperature, of the engine load, of driving modes, and so on. The control unit acts under the action of a driving program to drive the electromagnetic actuator based on a driving signal transmitted by the main management unit via the linking means. The driving signal determines the opening and closure angles in a 720° cycle of the crankshaft after a reference top dead center point of the piston of the cylinder concerned, and also the water temperature, the oil temperature, the engine speed, and so on.

With this system, the best performance levels for the engine can be obtained. However, should the signal originating from the main management unit be absent, for example because of a break in the link between the main management unit and the control unit, the control unit cannot drive the actuator, thus causing the heat engine to stop.

### OBJECT OF THE INVENTION

It would therefore be advantageous to have a means with which to enhance the reliability of the heat engine.

### SUMMARY OF THE INVENTION

To this end, there is provided, according to the invention, a control unit for one or more electromagnetic actuators of a heat engine valve, said control unit being able to be connected by linking means to a main management unit of the heat engine, the control unit acting under the effect of at least a first driving program for driving the actuator(s) based on a signal transmitted to the control unit by the main management unit via the linking means. The control unit includes a memory containing stop gap information and in that, if the signal is interrupted, the control unit uses a second driving program to drive the actuator(s) on the basis of the stop gap information.

Thus, should the signal be absent, the control unit can continue to drive the actuator by thus enabling the vehicle to operate and for example reach a garage for a repair. The actuator then in fact behaves like a conventional camshaft driving the actuator according to a fixed control profile.

According to one embodiment, the stop gap information includes the valve opening and closure angles according to a speed of the heat engine.

Said control unit may include an internal processing unit for converting a valve opening/closure command in an electric current, called primary, said instruction depending on said signal transmitted to the control unit by the main unit or, if the signal is interrupted, said stop gap information.

Said processing unit operates permanently, for example, either in slave mode relative to the main management unit, or in standalone mode, if the signal is interrupted.

The control unit may also include a voltage converter, able to deliver to said actuator(s) a secondary current, the voltage value of which depends on the voltage value of said primary current.

The invention also relates to an assembly of pairs consisting of a so-called control unit as described above and a so-called electromagnetic actuator driven by said control unit.

According to one embodiment, said assembly includes means for synchronizing the control units of said pairs.

The invention also relates to an assembly of a control unit as described above and of said electromagnetic actuators, driven by said control unit.

According to one embodiment, said control unit of said assembly is provided remote from said actuators.

Other features and advantages of the invention will emerge from reading the following description of a particular, nonlimiting embodiment of the invention.

### BRIEF DESCRIPTION OF THE DRAWINGS

Reference will be made to the appended drawings, in which:

FIG. 1 is a perspective schematic view of a heat engine according to the invention,

FIG. 2 is a partial schematic view in transverse cross section of this engine.

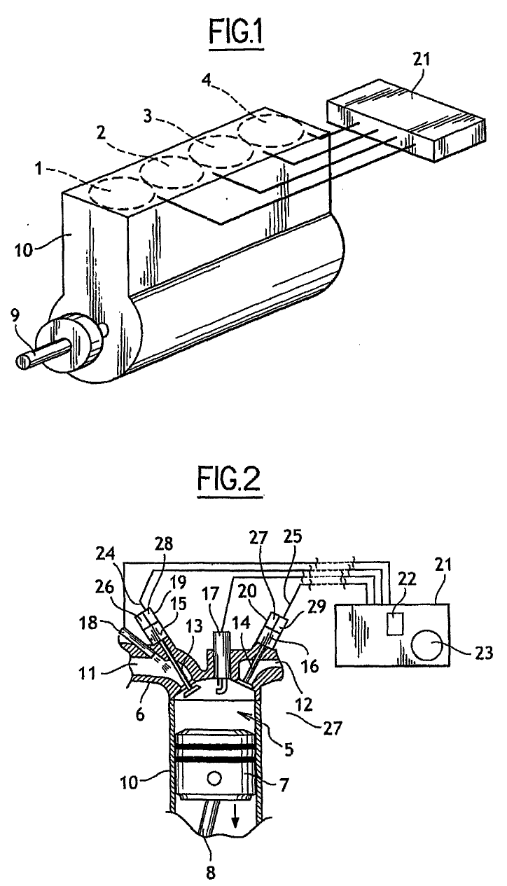

### DETAILED DESCRIPTION OF THE INVENTION

Referring to the figures, the heat engine according to the invention comprises a block 10 delimiting four in-line cylinders 1, 2, 3, 4. Each cylinder 1, 2, 3, 4 defines a chamber 5 sealed on the one hand by a cylinder block 6 and on the other hand by a mobile piston 7 sliding in the cylinder 1, 2, 3, 4 between two extreme positions (top dead center point and bottom dead center point) and connected by a connecting rod 8 to a crankshaft 9 mounted to pivot in the block 10.

An intake duct 11 and an exhaust duct 12 provided in the cylinder block 6 open out into each combustion chamber 5. The intake duct 11 and the exhaust duct 12 are respectively equipped with an intake valve 13 and an exhaust valve 14 that are moved between two open and closed positions by electromagnetic actuators 15, 16 respectively. Each electromagnetic actuator 15, 16 is driven by a control unit symbolized as 19, 20. In another embodiment, such actuators could be provided only at the intake or only at the exhaust.

A spark plug 17 is mounted on the cylinder block 6 to open into the combustion chamber 5. The spark plug 17 is connected to an ignition circuit that is known per se and not represented here.

An injector 18 fuel feed device is also mounted on the cylinder block 6.

The engine also includes a main management unit (or Engine Control Unit, ECU). This main management unit, represented with the reference 21, is notably connected to the injectors 18, to the electromagnetic actuators 15, 16, and to the ignition circuit to control said items. The management unit 21, known in itself, comprises, for example, a processing module 22 or computation module such as a processor associated with a memory 23 containing programs executed by the processing module 22.

In a manner that is known per se, the operating cycle of each of the cylinders is a four-stroke cycle comprising an intake phase (or stroke), a compression phase, an expansion phase and an exhaust phase. Each phase represents a quarter operating cycle, or a half revolution of the crankshaft.

In normal operating mode, the management unit 21, which is connected by linking means 24, 25 to the control units 19, 20 of the electromagnetic actuators 15, 16, transmits to the control units 19, 20 a signal which determines opening and closure angles of the valve concerned over a 720° cycle, the water and oil temperatures, a top dead center reference cue, and so on, in order to enable the control units 19, 20 to drive the electromagnetic actuators 15, 16 on the basis of the information contained in the received signal.

According to the invention, the control unit includes a memory 26, 27 containing stop gap information comprising, notably, valve opening and closure angles based on engine speed.

Should the signal be absent, for example because of a break in the link between the control unit 19, 20 and the management unit 21, the control unit 19, 20 executes a specific driving program by using the stop gap information contained in the memories 26, 27. Preferably, the stop gap information enables the actuators to be driven according to a profile corresponding to a standard drive, that is to say resulting from a trade-off between fuel consumption and performance.

The control unit is a smart unit, always active, operating, for example, either in slave mode relative to the main management unit, or in standalone mode, should the signal be interrupted. Said control unit also comprising, for example, an internal processing unit for converting a valve opening/closure command into an electrical current, called primary, said current depending on said signal transmitted to the control unit by the main unit or, should the signal be interrupted, on said stop gap information.

Said control unit may also include a voltage converter that is able to deliver to said actuator(s) a secondary current, the voltage value of which depends on the voltage value of said primary current.

Said control unit may, according to a first example which is not represented, be the same for all the actuators. It is provided with a remote unit and connected by an electrical connection, for currents intended to power a coil of an electromagnet, to each of the actuators.

According to another embodiment corresponding to the one illustrated, it may be provided on each actuator. Synchronization means, not represented, are provided to ensure the desired operating mode for the engine on all the cylinders, for example by correlating the internal processing units of each of said control units which can thus be clocked relative to one another.

Obviously, the invention is not limited to the embodiment described and variant embodiments can be applied thereto without departing from the framework of the invention as defined by the claims.

In particular, in sports vehicles, the stop gap information may be geared toward an actuator driving profile that corresponds to a sporty drive, that is to say, optimized to prioritize engine performance.

Furthermore, the memory 26, 27 may contain a number of driving programs and a variety of stop gap information.

1. A control unit for one or more electromagnetic actuators of a heat engine valve, comprising:
linking means for operatively connecting said control unit to a main management unit of the heat engine, the control unit acting under the effect of at least a first driving program for driving the actuator(s) based on a signal transmitted to the control unit by the main management unit via the linking means; and,
a memory comprising stop gap information,
wherein, when the signal is interrupted, the control unit uses a second driving program to drive the actuator(s) on the basis of the stop gap information.

2. The control unit as claimed in claim 1, wherein the stop gap information includes the valve opening and closure angles according to a speed of the heat engine.

3. The control unit as claimed in claim 1, further comprising an internal processing unit for converting a valve opening/closure command into a primary electric current, said primary current depending on said signal transmitted to the control unit by the main unit or, when the signal is interrupted, said primary current depending on said stop gap information.

4. The control unit as claimed in claim 3, wherein said processing unit operates permanently, in one selected from a group consisting of slave mode relative to the main management unit, or standalone mode, when the signal is interrupted.

5. The control unit as claimed in claim 3, further comprising a voltage converter, able to deliver to said actuator(s) a secondary current, the voltage value of which depends on the voltage value of said primary current.

6. An assembly of pairs comprising the control unit as claimed in claim 1 and an electromagnetic actuator driven by said control unit.

7. The assembly as claimed in claim 6, comprising means for synchronizing the control units of said assembly of pairs.

8. (canceled)

9. The assembly as claimed in claim 7, wherein said control unit is provided remote from said actuators.
